(19) United States
(12) Patent Application Publication
(10) Pub. No.: US 2026/0197928 A1
(43) Pub. Date: Jul. 9, 2026

(54) PLASMA REACTOR FOR GAS REFORMING, GAS REFORMING APPARATUS USING THE SAME, AND METHOD USING THE PLASMA REACTOR

(71) Applicant: Samsung Electronics Co., Ltd., Suwon-si (KR)

(72) Inventors: Jinwoo Kim, Suwon-si (KR); Dongwook Kim, Suwon-si (KR); Jaehee Chang, Suwon-si (KR)

(21) Appl. No.: 19/233,568

(22) Filed: Jun. 10, 2025

(30) Foreign Application Priority Data
Jan. 7, 2025 (KR) 10-2025-0002400

(51) Int. Cl. H05H 1/48

(52) U.S. Cl. CPC H05H 1/48; H05H 2245/10

(57) ABSTRACT

A gas reforming apparatus includes a plasma reactor for converting processing target gas into reformed gas. The plasma reactor includes a ground electrode forming an inner wall of a reaction space and a high-voltage electrode facing the ground electrode inside the reaction space and generating arc discharging. The high-voltage electrode has a cone shape including an enlargement portion, a reduction portion, and a boundary portion between the enlargement portion and the reduction portion. The reaction space includes a gas supply region between the enlargement portion and the inner wall, a discharging region between the reduction portion and the inner wall where the discharging occurs, and a connection region between the boundary portion and the inner wall and connecting the gas supply region to the discharging region. The processing target gas, plasma driving gas, and auxiliary gas are supplied to the gas supply region through at least one gas inlet.

### CROSS-REFERENCE TO RELATED APPLICATION

This application claims priority to Korean Patent Application No. 10-2025-0002400, filed on Jan. 7, 2025, and all the benefits accruing therefrom under 35 U.S.C. § 119, the content of which in its entirety is herein incorporated by reference.

### BACKGROUND

### 1. Field

The disclosure relates to a plasma reactor for gas reforming, a gas reforming apparatus using the same, and a method using the plasma reactor.

### 2. Description of the Related Art

Gas emitted by various industries includes a variety of materials (greenhouse gas) that may cause a greenhouse effect. In order to reduce the emission of greenhouse gas, a method of separating greenhouse gas from exhaust gas and a method of reforming the greenhouse gas into another gas that does not have a greenhouse effect have been studied. A gas reforming method includes a combustion-based reforming method in which the greenhouse gas is burnt by using heat to reform the gas, a catalytic method of forming a high-temperature environment of about 800° C. or higher and supplying energy to an active sites on a surface of a catalyst to reform the greenhouse gas according to a catalytic reaction, and a plasma method of reforming the greenhouse gas by forming a strong electric or magnetic field to break the bonds between gas molecules.

### SUMMARY

The disclosure provides a plasma reactor for gas reforming which may increase energy efficiency, a gas reforming apparatus using the same, and a method using the plasma reactor.

The disclosure provides a plasma reactor for gas reforming which may reduce startup time, a gas reforming apparatus using the same, and a method using the plasma reactor.

Additional aspects will be set forth in part in the description which follows and, in part, will be apparent from the description, or may be learned by practice of the presented embodiments of the disclosure.

According to an aspect of the disclosure, a gas reforming apparatus for converting processing target gas into reformed gas includes a gas supply unit configured to supply the processing target gas, plasma driving gas, and auxiliary gas for preventing a reverse reaction of the reformed gas, a plasma reactor configured to receive the processing target gas, the plasma driving gas, and the auxiliary gas and convert the processing target gas into the reformed gas by using plasma generated by arc discharging, and a gas storage configured to receive the reformed gas discharged from the plasma reactor, where the plasma reactor includes: a housing having a reaction space therein, at least one gas inlet connected to the gas supply unit, and a gas outlet through which the reformed gas is discharged; a ground electrode arranged in the reaction space and forming an inner wall of the reaction space; and a high-voltage electrode arranged inside the reaction space to face the ground electrode and configured to generate the arc discharging, the high-voltage electrode has a cone shape including an enlargement portion, a reduction portion, and a boundary portion between the enlargement portion and the reduction portion, the reaction space includes a gas supply region between the enlargement portion and the inner wall, a discharging region which is a region between the reduction portion and the inner wall and in which the arc discharging occurs, and a connection region which is a region between the boundary portion and the inner wall and connects the gas supply region to the discharging region, and the at least one gas inlet is connected to the gas supply region.

In an embodiment, the connection region may form a bottleneck portion between the gas supply region and the discharging region.

In an embodiment, an angle of the enlargement portion with respect to a reference line orthogonal to a gas flow direction may be greater than an angle of the reduction portion with respect to the reference line.

In an embodiment, the gas reforming apparatus may further include a mixer configured to form mixed gas by mixing the processing target gas, the plasma driving gas, and the auxiliary gas, and the at least one gas inlet may be connected to the mixer such that the mixed gas is supplied to the gas supply region of the reaction space.

In an embodiment, the processing target gas, the plasma driving gas, and the auxiliary gas may be individually supplied to the at least one gas inlet and mixed with each other in the gas supply region of the reaction space.

In an embodiment, the processing target gas may include at least one of nitrogen oxide and fluorocarbon.

In an embodiment, the auxiliary gas may include at least one of hydrogen, oxygen, water vapor, argon, and helium.

According to another aspect of the disclosure, a plasma reactor for converting processing target gas into reformed gas, includes a housing having a reaction space therein, at least one gas inlet through which the processing target gas, plasma driving gas, and auxiliary gas for preventing a reverse reaction of the reformed gas are injected into the reaction space, and a gas outlet through which the reformed gas is discharged, a ground electrode arranged in the reaction space and configured to form an inner wall of the reaction space, and a high-voltage electrode arranged in the reaction space to face the ground electrode and configured to generate the arc discharging. The high-voltage electrode has a cone shape including an enlargement portion, a reduction portion, and a boundary portion between the enlargement portion and the reduction portion, the reaction space includes a gas supply region between the enlargement portion and the inner wall, a discharging region which is a region between the reduction portion and the inner wall and in which the arc discharging occurs, and a connection region which is a region between the boundary portion and the inner wall and connects the gas supply region to the discharging region, and the at least one gas inlet is connected to the gas supply region.

In an embodiment, the connection region may form a bottleneck portion between the gas supply region and the discharging region.

In an embodiment, an angle of the enlargement portion with respect to a reference line orthogonal to a gas flow direction may be greater than an angle of the reduction portion with respect to the reference line.

In an embodiment, the at least one gas inlet may be formed in a tangential direction with respect to the inner wall of the gas supply region.

In an embodiment, the at least one gas inlet may be formed in a direction orthogonal to the inner wall of the gas supply region.

In an embodiment, the processing target gas may include at least one of nitrogen oxide and fluorocarbon.

In an embodiment, the auxiliary gas may include at least one of hydrogen, oxygen, water vapor, argon, and helium.

According to another aspect of the disclosure, a gas reforming method includes supplying the processing target gas, the plasma driving gas, and the auxiliary gas to the gas supply region of the reaction space through the at least one gas inlet of the plasma reactor, supplying mixed gas of the processing target gas, the plasma driving gas, and the auxiliary gas to the discharging region through the connection region to form a turbulence of the mixed gas in the discharging region, applying a pulse voltage to the high-voltage electrode of the plasma reactor to form plasma in the discharging region, converting the processing target gas into the reformed gas by energy exchange with the plasma, and discharging the reformed gas from the plasma reactor.

In an embodiment, the supplying of the processing target gas, the plasma driving gas, and the auxiliary gas to the gas supply region may include supplying the processing target gas, the plasma driving gas, and the auxiliary gas to a mixer to form the mixed gas, and supplying the mixed gas to the gas supply region through the at least one gas inlet.

In an embodiment, the supplying of the processing target gas, the plasma driving gas, and the auxiliary gas to the gas supply region may include individually supplying the processing target gas, the plasma driving gas, and the auxiliary gas to the at least one gas inlet, and mixing the processing target gas, the plasma driving gas, and the auxiliary gas in the gas supply region to form the mixed gas.

In an embodiment, the processing target gas may include at least one of nitrogen oxide and fluorocarbon.

In an embodiment, the auxiliary gas may include at least one of hydrogen, oxygen, water vapor, argon, and helium.

In an embodiment, the pulse voltage may have a pulse width of about 1 microsecond (μs) to about 100 μs and a pulse period of about 1 kHz to about 100 KHz.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic configuration diagram of a gas reforming apparatus according to an embodiment;

FIG. 2 is a schematic half-cross-sectional view illustrating a high-voltage electrode and a ground electrode according to an embodiment;

FIGS. 3 and 4 are cross-sectional views orthogonal to a gas flow direction illustrating examples of arrangements of gas inlets;

FIG. 5 is a schematic diagram of a gas reforming apparatus according to an embodiment;

FIG. 6 is a flowchart of a gas reforming method according to an embodiment;

FIG. 7 illustrates simulation results regarding a flow rate of a mixed gas inside a reaction space;

FIG. 8 illustrates simulating results regarding a flow of a mixed gas inside a reaction space;

FIG. 9 is a graph illustrating an example of N₂O decomposition performance evaluation for a gas reforming apparatus and method according to an embodiment; and

FIGS. 10 and 11 are graphs illustrating examples of CF₄ decomposition performance evaluation for a gas reforming apparatus and method according to an embodiment, where FIG. 10 illustrates a removal rate and FIG. 11 illustrates energy efficiency.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept described below may be modified into various forms and may have various embodiments, and specific embodiments are illustrated in the drawings and described in detail. However, this is not intended to limit the present inventive concept to specific embodiments, and should be understood to include all modifications, equivalents, or substitutes included in the technical scope of the present inventive concept.

Terms used below are described in detail with respect to a carbon dioxide capture device and method according to various embodiments with reference to the attached drawings. In the drawings below, the same reference numerals refer to the same components, and sizes of respective components in the drawings may be exaggerated for clarity and convenience of description. Terms, such as first, second, and so on may be used to describe various components, but the components should not be limited by the terms. Terms are used only for the purpose of distinguishing one component from another component.

Singular expressions include plural expressions unless the context clearly indicates otherwise. Also, when a portion is said to “include” a component, this does not mean that the portion excludes other components unless otherwise specifically stated, but rather that the portion may include other components. Also, sizes or thicknesses of respective components in the drawings may be exaggerated for clarity of description. Also, when a certain material layer is described as existing on a substrate or another layer, the material layer may exist in direct contact with the substrate or another layer, or a third layer may exist therebetween. Also, because the materials forming respective layers in the embodiments below are examples, other materials may be used therefor.

Also, the terms “ . . . portion/unit”, “module”, or so on described in the specification mean a unit that processes at least one function or operation, which may be implemented with hardware or software, or a combination of hardware and software.

The specific implementations described in the embodiments are examples and do not limit the technical scope in any way. In order to simplify the specification, descriptions of conventional electronic components, control systems, software, and other functional aspects of the above systems may be omitted. Also, connections or lack of connections between the components illustrated in the drawings are merely examples of functional connections and/or physical or circuit connections, and may be represented in actual devices as alternative or additional various functional connections, physical connections, or circuit connections.

“About” or “substantially equal” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially equal” can mean within one or more standard deviations, or within +10%, 5% or 2% of the stated value.

Operations of methods may be performed in any suitable order unless there is an explicit statement that the operations have to be performed in the order described. Also, the use of all example terms (for example, and so on) is intended merely to describe the technical idea and does not limit the scope of the claims by such terms unless otherwise defined by the claims.

A gas reforming method includes a combustion-based reforming method, a catalytic method, and a plasma method, and so on. The combustion-based reforming method requires a combustion process for preparing a high-temperature environment, but there is a problem that carbon dioxide is generated during the combustion process. In a thermal catalyst-based reforming method, a catalyst provides high activity in a high-temperature environment. However, when the catalyst is continuously exposed to the high-temperature environment, a shape and/or structure of the catalyst may collapse due to high fluidity of elements included in gas and a side reaction of fluorine (F)-based reactants. For example, a surface area of the catalyst compared to a volume of the catalyst may be reduced due to sintering of an active point of the catalyst, and a reaction speed may be reduced due to poisoning as foreign materials are deposited in the active point. Also, the thermal catalyst-based reforming method requires a high-temperature environment of about 800° C. or more to activate a reforming system. In order to reach this environment, energy supply is required, and it takes time until a target temperature is reached, and accordingly, it is difficult for the reforming system to operate immediately. The energy and time consumed in this system activation process are surplus resources that are not involved in gas reforming.

There are two types of plasma methods: a transfer-type plasma method and a non-transfer-type plasma method. The transfer-type plasma method is a method of injecting processing target gas into a rear end of the flame generated by the driving gas. The transfer-type method consumes a lot of energy because it is difficult to smoothly mix a processing target with plasma flame and to exchange heat between the processing target and the plasma flame due to a high viscosity of the high-temperature plasma flame. The non-transfer-type plasma method is a method of providing a processing target in the middle of the flame generated by plasma, that is, in a space where the flame is generated, and it is difficult to effectively exchange heat between plasma flame and the processing target. In practice, the transfer-type and non-transfer-type plasma methods are plasma methods used for surface coating, welding, cutting, and so on, and are used when a processing target is not greatly affected by the fluidity of plasma flame, such as a metal rod. That is, the plasma methods are not systems that treat gaseous materials, such as process exhaust gas.

The disclosure provides a plasma reactor for gas reforming that may reform gas by utilizing an electric field and the energy of active species or electrons in plasma, and a gas reforming apparatus and method using the plasma reactor. The disclosure provides a plasma reactor for gas reforming that may efficiently transfer energy to processing target gas and increase energy efficiency by first mixing plasma driving gas with processing target gas, and then converting the mixed gas into plasma, and a gas reforming apparatus and method using the plasma reactor. The disclosure provides a plasma reactor for gas reforming that may start up immediately, and a gas reforming apparatus and method using the plasma reactor.

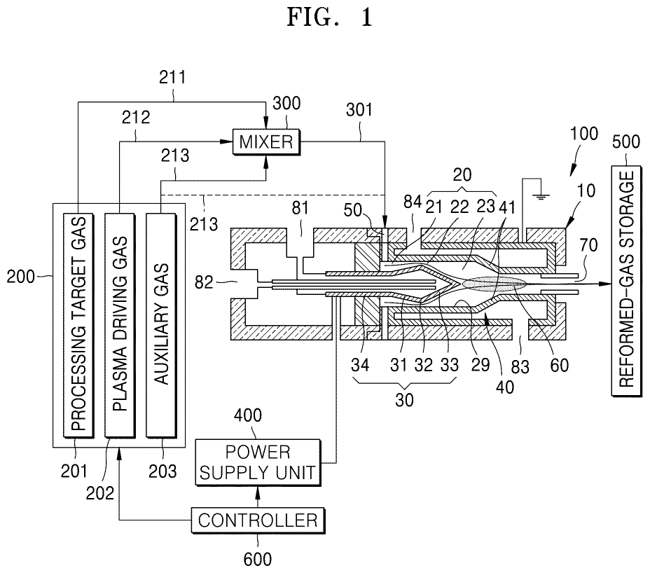

FIG. 1 is a schematic diagram of a gas reforming apparatus according to an embodiment. Referring to FIG. 1, the gas reforming apparatus may convert processing target gas 201 into reformed gas. The gas reforming apparatus may include a plasma reactor 100, a gas supply unit 200, and a reformed-gas storage 500.

The plasma reactor 100 may include a housing 10, a high-voltage electrode 30, and a ground electrode 40. The housing 10 may form a body of the plasma reactor 100. The housing 10 may include a reaction space 20, one or more gas inlets 50, and a gas outlet 70. The gas inlets 50 may be connected to the gas supply unit 200, and the processing target gas 201, plasma driving gas 202, and auxiliary gas 203 may be supplied to the reaction space 20 through the gas inlets 50. The reformed gas is discharged from the reaction space 20 through the gas outlet 70. The reformed gas may be accommodated in, for example, the reformed-gas storage 500.

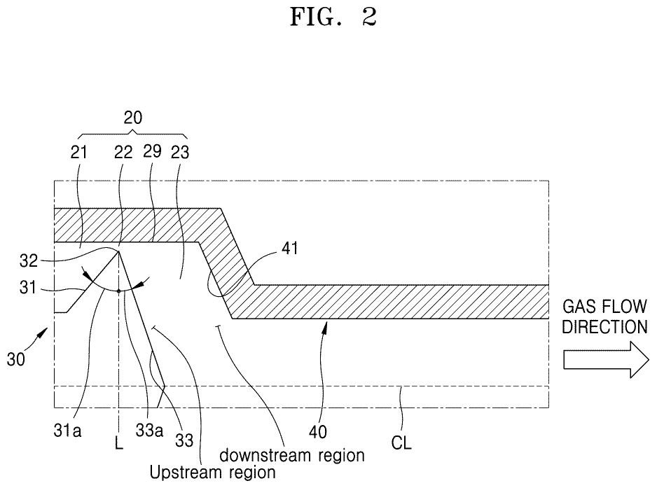

FIG. 2 is a schematic half-cross-sectional view illustrating the high-voltage electrode 30 and the ground electrode 40 according to an embodiment. Referring to FIGS. 1 and 2, the ground electrode 40 may be arranged in the reaction space 20 to form an inner wall 29 of the reaction space 20. The inner wall 29 may form a gas flow path in the reaction space 20. The reaction space 20 may have, for example, a hollow cylindrical shape. The high-voltage electrode 30 may be an electrode to which a high voltage is applied so as to generate arc discharging. The high-voltage electrode 30 is inside the reaction space 20 opposite to the ground electrode 40 to generate arc discharging. The ground electrode 40 may be spaced apart from the high-voltage electrode 30 and may generate the arc discharging due to a voltage difference between the ground electrode 40 and the high-voltage electrode 30. The high-voltage electrode 30 and the ground electrode 40 may each be formed of a heat-resistant metal, such as stainless steel, carbon steel, or Inconel.

The high-voltage electrode 30 may have a cone shape including an enlargement portion 31, a reduction portion 33, and a boundary portion 32 between the enlargement portion 31 and the reduction portion 33. The enlargement portion 31 may extend from a body portion 34, and an interval between the enlargement portion 31 and an inner wall 29 of the reaction space 20 may gradually decrease toward the boundary portion 32 in a gas flow direction. For example, the body portion 34 may have a cylindrical shape, and a diameter of the enlargement portion 31 may gradually increase from the body portion 34 having a cylindrical shape in the gas flow direction. The reduction portion 33 may extend from the boundary portion 32, and an interval between the reduction portion 33 and the inner wall 29 of the reaction space 20 may gradually increase in the gas flow direction. For example, a diameter of the reduction portion 33 may gradually decrease from the boundary portion 32 in the gas flow direction, and a downstream end of the reduction portion 33 in the gas flow direction may be sharp (See FIG. 1). Therefore, the high-voltage electrode 30 may have a downstream end of which entire shape is a sharp cone shape. Inclination angles of the enlargement portion 31 and the reduction portion 33, for example, inclination angles 31a and 33a of the enlargement portion 31 and the reduction portion 33 with respect to a reference line L orthogonal to a center line CL of the gas flow direction, may be equal to each other or may also be different from each other. In the embodiment, the inclination angle 31a of the enlargement portion 31 with respect to the reference line L may be greater than the inclination angle 33a of the reduction portion 33 with respect to the reference line L. That is, a diameter of the enlargement portion 31 may increase relatively gradually toward the boundary portion 32, and a diameter of the reduction portion 33 may decrease relatively rapidly as a distance from the boundary portion 32 increases.

The reaction space 20 may be divided into three regions by the high-voltage electrode 30. For example, the reaction space 20 may include a gas supply region 21 between the enlargement portion 31 and the inner wall 29, a discharging region 23 between the reduction portion 33 and the inner wall 29, and a connection region 22 between the boundary portion 32 and the inner wall 29. Because the interval between the enlargement portion 31 and the inner wall 29 of the reaction space 20 gradually decreases toward the boundary portion 32 in the gas flow direction, a cross-sectional area of a flow path of the gas supply region 21 gradually decreases in the gas flow direction. In the connection region 22, a cross-sectional area of a flow path may be minimal, and a bottleneck portion of the gas flow may be formed by the connection region 22. A cross-sectional area of a flow path of the discharging region 23 may increase rapidly in an upstream region where the reduction portion 33 is arranged and may decrease again in a downstream region where an opposing portion 41 described below is arranged. As described above, the inclination angle 31a of the enlargement portion 31 with respect to the reference line L orthogonal to the center line CL of the gas flow direction may be greater than the inclination angle 33a of the reduction portion 33 with respect to the reference line L. A diameter of the reduction portion 33 decreases relatively rapidly as a distance from the boundary portion 32 in the gas flow direction increases, and the cross-sectional area of the flow path of the discharging region 23 increases rapidly as a distance from the connection region 22 in the gas flow direction increases in the upstream region. Due to this, as described below, a turbulence is formed in the discharging region 23, and accordingly, heat exchange between plasma and the processing target gas 201 may be effectively performed.

The ground electrode 40 may include the opposing portion 41 that faces the reduction portion 33 of the high-voltage electrode 30 in the discharging region 23. The reduction portion 33 is separated from the opposing portion 41 with the discharging region 23 therebetween. The reduction portion 33 may be parallel to or may not be parallel to the opposing portion 41. Although an interval between the reduction portion 33 and the opposing portion 41 is exaggerated in FIGS. 1 and 2, the exaggerated interval indicates only that the reduction portion 33 is separated from the opposing portion 41, and the interval between the reduction portion 33 and the opposing portion 41 illustrated in FIGS. 1 and 2 does not indicate an actual interval. The interval between the reduction portion 33 and the opposing portion 41 may be determined appropriately to generate arc discharging. Discharging, for example, arc discharging, occurs in the discharging region 23. The opposing portion 41 forms a part of the inner wall 29.

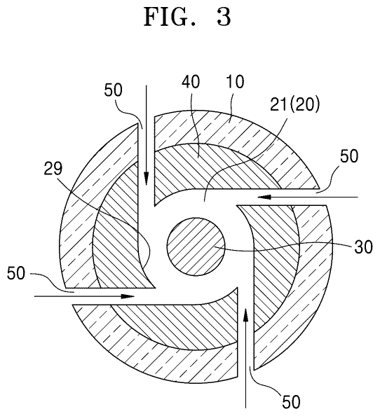

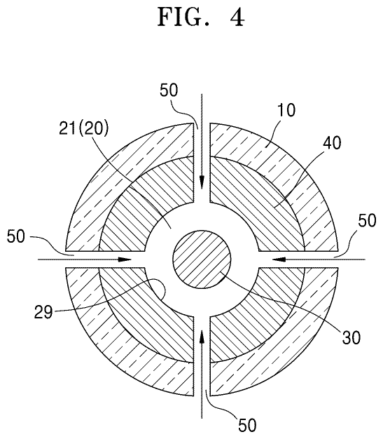

The gas inlets 50 may be connected to the gas supply region 21. FIGS. 3 and 4 are cross-sectional views orthogonal to a gas flow direction which illustrate examples of arrangements of the gas inlets 50. In an embodiment, referring to FIG. 3, the gas inlets 50 may be formed in a tangential direction with respect to the inner wall 29 of the reaction space 20, for example, the gas supply region 21. In an embodiment, referring to FIG. 4, the gas inlets 50 may be formed in a direction (normal direction) orthogonal to the inner wall 29 of the reaction space 20, for example, the gas supply region 21. Although FIGS. 3 and 4 illustrate that four gas inlets 50 are arranged at intervals of 90 degrees, the number and arrangement interval of the gas inlets 50 are not limited thereto. The number of gas inlets 50 may be three or less or may be five or more. Inclination angles of the gas inlets 50 in a cross section orthogonal to the gas flow direction are not limited to the examples illustrated in FIGS. 3 and 4. For example, the gas inlets 50 may each have an inclination angle between a tangential direction and a normal direction with respect to the inner wall 29. Although not illustrated in the drawings, the inclination angles of the gas inlet 50 in the gas flow direction are not limited in particular. For example, the gas inlets 50 may each have an angle of 90 degrees with respect to the gas flow direction and may also be inclined at an inclination angle less than 90 degrees with respect to the gas flow direction.

Reference symbols 81, 82, 83, and 84 represent supply/discharge holes of a coolant. The coolant may include, for example, water.

The gas supply unit 200 supplies the processing target gas 201, the plasma driving gas 202, and the auxiliary gas 203 to the plasma reactor 100. The processing target gas 201 may be discharged from, for example, a semiconductor process. For example, the processing target gas 201 may include at least one of F-gas (fluorinated greenhouse gas) and nitrogen oxide. The F-gas may include, for example, fluorinated carbon gas (CF gas). The nitrogen oxide may include, for example, N₂O. The plasma driving gas 202 may form plasma and include at least one of inert gases, such as nitrogen (N). The inert gases may include, for example, argon (Ar) and helium (He). The auxiliary gas 203 may reduce a reverse reaction of reforming gas and include at least one of, for example, hydrogen (H), oxygen (O), water vapor (H₂O), helium (He), and argon (Ar). The gas supply unit 200 may supply gas by adjusting a flow amount of each gas by using, for example, a mass flow meter (not illustrated).

Referring to FIG. 1, the gas reforming apparatus may further include a mixer 300. The mixer 300 may mix the processing target gas 201, the plasma driving gas 202, and the auxiliary gas 203 to form a mixed gas. The mixer 300 may be connected to the gas inlets 50. For example, the processing target gas 201, the plasma driving gas 202, and the auxiliary gas 203 may be supplied to the mixer 300 respectively through the first, second, and third gas supply lines 211, 212, and 213 to be mixed with each other inside the mixer 300. The mixer 300 may be connected to the gas inlets 50 by a fourth gas supply line 301, and the mixed gas may be supplied to the gas inlets 50 through the fourth gas supply line 301.

The mixer 300 may also mix the processing target gas 201 with the plasma driving gas 202. For example, the processing target gas 201 and the plasma driving gas 202 may be supplied to the mixer 300 respectively through the first and second gas supply lines 211 and 212 to be mixed with each other inside the mixer 300. The mixer 300 may be connected to the gas inlets 50 by the fourth gas supply line 301, and the mixed gas of the processing target gas 201 and the plasma driving gas 202 may be supplied to the gas inlets 50 through the fourth gas supply line 301. The auxiliary gas 203 may be supplied to the reaction space 20, that is, the gas supply region 21, through the gas inlet 50 without passing through the mixer 300. For example, as illustrated in a dotted line in FIG. 1, the third gas supply line 213 may be connected to the gas inlet 50. In this case, the third gas supply line 213 and the fourth gas supply line 301 may be connected to different gas inlets among a plurality of gas inlets 50 and may be connected to each of the plurality of gas inlets 50.

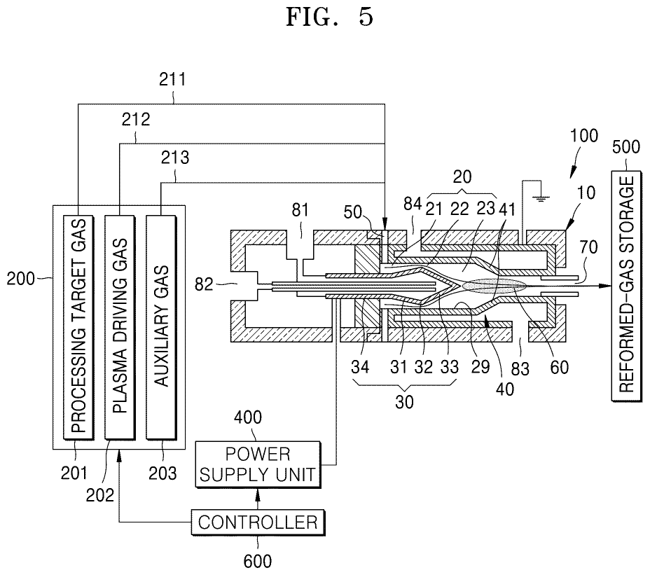

As illustrated in FIG. 5, the processing target gas 201, the plasma driving gas 202, and the auxiliary gas 203 may be individually supplied to the gas inlets 50 and mixed with each other inside the reaction space 20, that is, the gas supply region 21, to form a mixed gas. For example, the processing target gas 201, the plasma driving gas 202, and the auxiliary gas 203 may be supplied to the gas inlet 50 respectively through the first, second, and third gas supply lines 211, 212, and 213. In this case, the first, second, and third gas supply lines 211, 212, and 213 may be connected to different gas inlets among the plurality of gas inlets 50, and may also be connected to each of the plurality of gas inlets 50.

A power supply unit 400 may apply a voltage, for example, a pulse voltage, to the high-voltage electrode 30. For example, the pulse voltage may have a pulse width of 1 microsecond (μs) to 100 μs and a pulse cycle of 1 kHz to 100 kHz. The pulse voltage may have the highest voltage of, for example, 0.5 kilovolts (kV) to 10 kV.

A controller 600 may control an operation of the gas reforming apparatus. The controller 600 may control respective components of the gas reforming apparatus. For example, the controller 600 may include at least one processor and at least one memory. The processor may control components of the gas reforming apparatus by executing a program stored in the memory and may perform various types of data processing or arithmetic to operate the gas reforming apparatus. Although not illustrated in the drawings, the gas reforming apparatus may further include an analyzer that analyzes components of the reformed gas stored in the reformed-gas storage 500, and the controller 600 may control the supply amount of each gas supplied from the gas supply unit 200, parameters of a pulse voltage applied to the high-voltage electrode 30 by the power supply unit 400, and so on based on an analysis result of the analyzer.

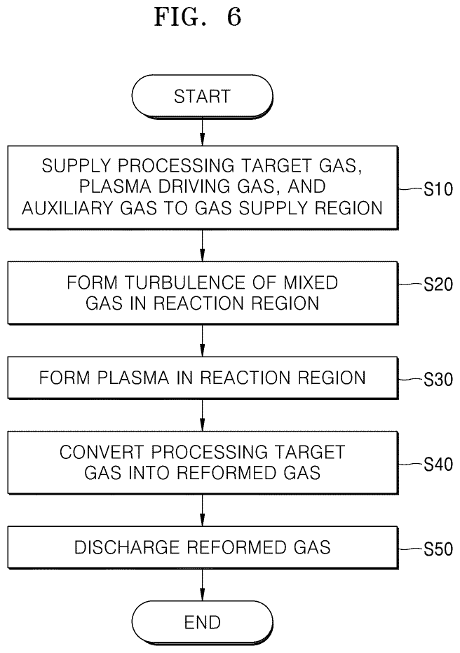

FIG. 6 is a flowchart of a gas reforming method according to an embodiment. Embodiments of the gas reforming method are described with reference to FIGS. 1 to 6.

First, the processing target gas 201, the plasma driving gas 202, and the auxiliary gas 203 may be supplied to the gas supply region 21 of the reaction space 20 through the gas inlet 50 of the plasma reactor 100 (S10). For example, the processing target gas 201 may be discharged from, for example, a semiconductor process. The processing target gas 201 may include at least one of F-gas (fluorinated greenhouse gas) and nitrogen oxide. The plasma driving gas 202 may form plasma and include at least one of inert gases, such as nitrogen (N), argon (Ar), and helium (He). The auxiliary gas 203 may reduce a reverse reaction of the reformed gas and include at least one of, for example, hydrogen (H), oxygen (O), water vapor (H₂O), helium (He), and argon (Ar). The processing target gas 201, the plasma driving gas 202, and the auxiliary gas 203 may be supplied by the gas supply unit 200. The gas supply unit 200 may adjust a supply flow amount of each gas by using a mass flow meter (not illustrated).

The processing target gas 201, the plasma driving gas 202, and the auxiliary gas 203 may be mixed by the mixer 300 to form a mixed gas, and the mixed gas may be supplied to the reaction space 20, that is, the gas supply region 21, through the fourth gas supply line 301 and the gas inlet 50. In addition, the processing target gas 201 and the plasma driving gas 202 may be mixed by the mixer 300 and supplied to the gas supply region 21 through the fourth gas supply line 301 and the gas inlet 50, and the auxiliary gas 203 may be supplied to the gas supply region 21 through the third gas supply line 213 and the gas inlet 50 without passing through the mixer 300. Also, the processing target gas 201, the plasma driving gas 202, and the auxiliary gas 203 may be individually supplied to the gas inlet 50 and be mixed with each other inside the reaction space 20, that is, inside the gas supply region 21, to form a mixed gas.

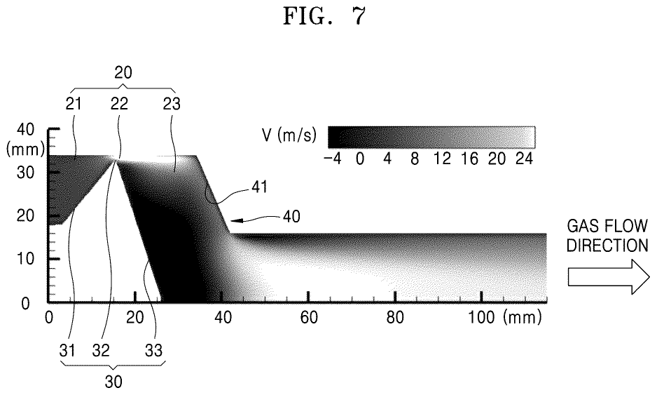

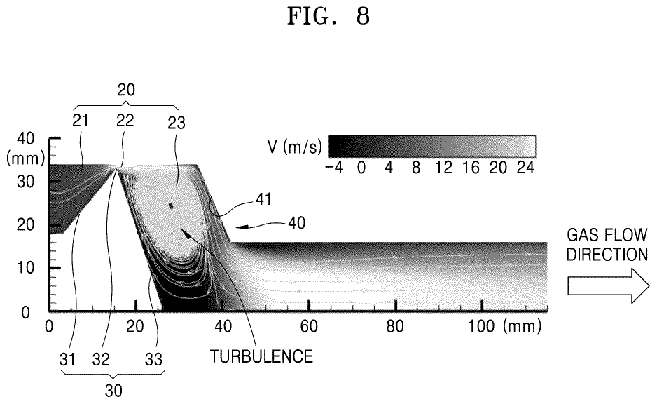

Next, the mixed gas may be supplied from the gas supply region 21 to the discharging region 23 through the connection region 22 to form a turbulence of the mixed gas in the discharging region 23 (S20). FIG. 7 illustrates a result of simulating a flow rate of the mixed gas inside the reaction space 20. FIG. 8 illustrates a result of simulating a flow of the mixed gas inside the reaction space 20. Referring to FIGS. 7 and 8, the boundary portion 32 of the high-voltage electrode 30 may have a small interval with the ground electrode 40, that is, the inner wall 29, and accordingly, a cross-sectional area of a flow path of the connection region 22 may also be reduced. Therefore, when the mixed gas in the gas supply region 21 passes through the connection region 22, a flow rate of the mixed gas increases rapidly. When the mixed gas is input to the discharging region 23, the cross-sectional area of the flow path increases rapidly, and accordingly, the flow rate of the mixed gas decreases rapidly. As described above, the inclination angle 31a of the enlargement portion 31 with respect to the reference line L orthogonal to the center line CL of a gas flow direction may be greater than the inclination angle 33a of the reduction portion 33 with respect to the reference line L. A diameter of the reduction portion 33 may decrease relatively rapidly as a distance from the boundary portion 32 increases, and a cross-sectional area of a flow path of the discharging region 23 increases rapidly as a distance from the connection region 22 increases. The mixed gas may swirl and form a turbulence in the discharging region 23, that is, a region between the reduction portion 33 of the high-voltage electrode 30 and the opposing portion 41 of the ground electrode 40. As a result, heat exchange between plasma and the processing target gas 201 may be effectively performed in the discharging region 23. Because the cross-sectional area of the flow path of the discharging region 23 decreases toward a downstream side in the gas flow direction, the flow rate of the mixed gas may increase again.

Next, a pulse voltage may be applied to the high-voltage electrode 30 of the plasma reactor 100 to form plasma 60 in the discharging region 23. For example, the pulse voltage may have a pulse width of 1 μs to 100 μs and a pulse cycle of 1 kHz to 100 KHz. The pulse voltage may have the highest voltage of, for example, 0.5 kV to 10 kV.

By adjusting a pulse width of the pulse voltage applied to the high-voltage electrode 30, maintenance time and operation time of linear arc discharging may be controlled. The operation time is maintenance time of the plasma 60 generated once. When the pulse width decreases greatly, arc discharging does not sufficiently supply the energy required for gas reforming, and when the pulse width increases greatly, the arc discharging may occur discontinuously and repeatedly within one pulse, and accordingly, the volume of unprocessed gas may increase. By applying a pulse voltage in the range described above, linear arc discharging may be maintained. Maintaining the linear arc discharging is advantageous for forming a localized super-high temperature region. In addition, the pulse voltage may be applied as an alternating current. The frequency of occurrence of linear discharging may be controlled by controlling the frequency of the alternating current. Accordingly, the entire energy of reaction gas may be controlled, and a gas temperature and reforming efficiency may be controlled.

The arc discharging occurs between the high-voltage electrode 30 and the ground electrode 40, and the arc plasma 60 is formed in the discharging region 23 by the arc discharging. Unlike the plasma driving gas 202 that is easily arc-discharged at a low voltage to form plasma, the processing target gas 201 requires a high voltage to be converted into plasma. According to the present embodiment, an interval between the boundary portion 32 of the high-voltage electrode 30 and the ground electrode 40 is narrower, and accordingly, instantaneous linear discharging occurs from the connection region 22, and the mixed gas including the processing target gas 201 may be directly converted into plasma. In this way, by directly transferring electric energy to the processing target gas 201 to directly form plasma, efficient energy supply to the mixed gas including the processing target gas 201 may be performed.

The processing target gas 201 may be converted into reformed gas by exchanging energy with the plasma 60 (S40). A stream of the plasma 60 starting from the connection region 22 extends to the discharging region 23 by a flow of the mixed gas to fill the discharging region 23. Accordingly, energy may be supplied to the mixed gas including the processing target gas 201 through acceleration and collision of electrons and ions, resistance heating by a current, energy exchange with high-energy active species, and so on in the discharging region 23. Because a cross-sectional area of a flow path increases rapidly from the connection region 22 toward the discharging region 23, a turbulence of the mixed gas may be actively generated in the discharging region 23, and energy exchange between the stream of the plasma 60 and the mixed gas including the processing target gas 201 may be effectively performed. The mixed gas including the processing target gas 201 may be additionally converted into plasma within the discharging region 23. Also, because a turbulence is formed in the discharging region 23, an arc generation point may be actively changed without being fixed. Therefore, local wear of the high-voltage electrode 30 and the ground electrode 40 due to the fixed arc generation point may be reduced or prevented. A downstream side of the discharging region 23 has a cross-sectional area of a flow path that decreases in a gas flow direction. Accordingly, the arc plasma 60 formed between the high-voltage electrode 30 and the ground electrode 40 may have a linear shape. The linear arc plasma 60 may be advantageous in forming a local ultra-high temperature region.

In this way, the mixed gas including the processing target gas 201 may be converted into plasma by arc discharging while passing through the connection region 22. The processing target gas 201 may be converted into reformed gas by direct bonding-decomposition of a plasma conversion process and thermodynamic bonding-decomposition by energy transferred from the gas converted into plasma. In a high temperature environment inside the discharging region 23, the reformed gas may be converted into the processing target gas 201 or another gas by reverse reaction. Because the reverse reaction of the reformed gas is prevented by the auxiliary gas, a reforming efficiency and energy efficiency may be improved.

The reformed gas is discharged from the plasma reactor 100 through the gas outlet 70 (S50). The reformed gas may be discharged into the atmosphere and may be stored in the reformed-gas storage 500.

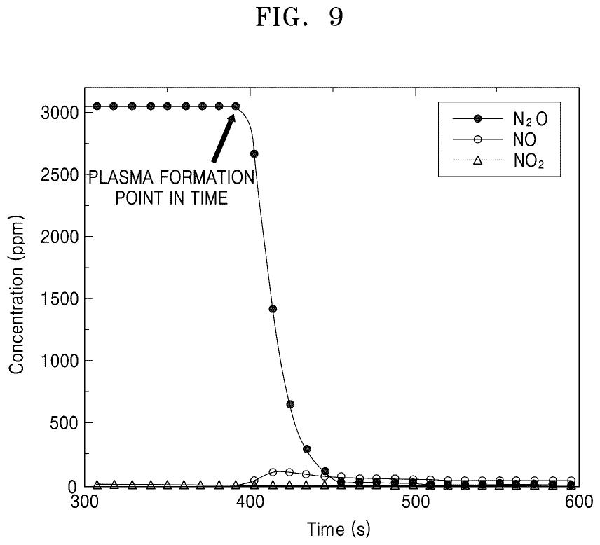

FIG. 9 is a graph illustrating an example of an N₂O decomposition performance evaluation according to a gas reforming apparatus and method of an embodiment. Evaluation conditions are as follows.

The greatest inner diameter of the ground electrode 40 of the plasma reactor 100 may be about 17 millimeters (mm), and an inner diameter of the gas outlet 70 may be about 10 mm. A length of the reaction space 20 in the gas flow direction may be about 18 mm. The greatest inner diameter of the ground electrode 40 may be the inner diameter of the ground electrode 40 near the gas supply region 21 and the connection region 22. The greatest diameter of the high-voltage electrode 30, that is, a diameter of the boundary portion 32, may be about 15 mm. Therefore, the width of the connection region 22 may be about 1 mm. A pulse voltage applied to the high-voltage electrode 30 may have the highest voltage of 2 kV, a pulse width of 5 μs, and a frequency of 50 KHz. The mixed gas of 3000 parts per million (ppm) including N₂O as the processing target gas 201 may be supplied through the gas inlet 50 of the plasma reactor 100 at a flow rate of 10 Litter per minute (Lpm) under the N₂ balance condition. N₂ is the plasma driving gas 202.

Referring to FIG. 9, after an operation of the plasma reactor 100 starts, a removal rate of N₂O within 1 minute may be approximately 98%, and a removal rate of N₂O within approximately 2 minutes may be approximately 99.5%. The final N₂O concentration may be 16 ppm, the consumed power may be approximately 803 W, and the energy efficiency may be 4.4 gN₂O/kWh. Although the embodiment does not use auxiliary gas, a high removal rate of N₂O and energy efficiency may be obtained by a structure of the reaction space 20 and the formation of turbulence according thereto. When, for example, H₂, H₂O, NH₃, and so on are supplied as the auxiliary gas 203, it is expected that a higher removal rate and energy efficiency may be obtained.

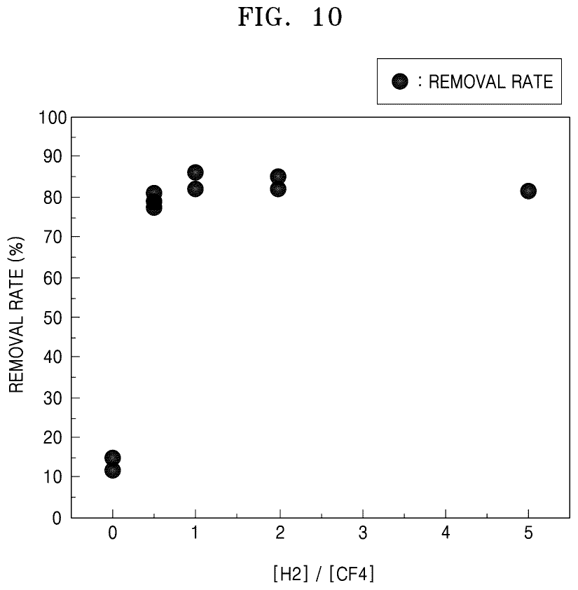

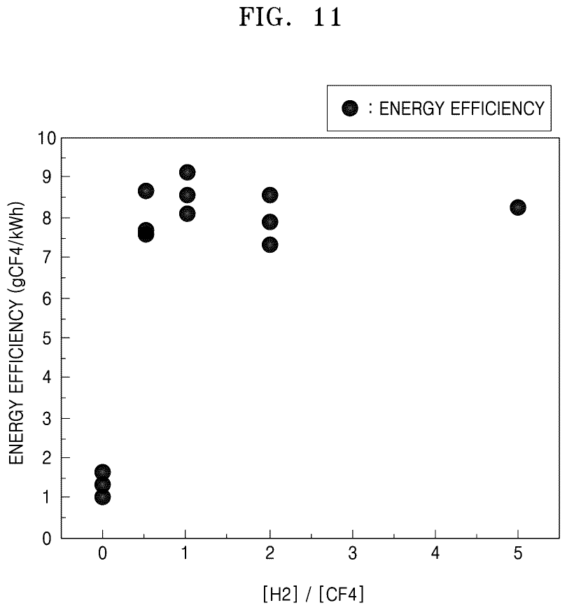

FIGS. 10 and 11 are graphs illustrating an example of CF₄ decomposition performance evaluation according to a gas reforming apparatus and method of an embodiment, where FIG. 10 illustrates the removal rate and FIG. 11 illustrates the energy efficiency.

The greatest inner diameter of the ground electrode 40 of the plasma reactor 100 may be about 17 mm, and an inner diameter of the gas outlet 70 may be about 10 mm. A length of the reaction space 20 may be about 18 mm. The greatest diameter of the high-voltage electrode 30, that is, a diameter of the boundary portion 32, may be about 15 mm. A pulse voltage applied to the high-voltage electrode 30 may have the highest voltage of 2 kV, a pulse width of 5 μs, and a frequency of 50 KHz. The mixed gas of 3000 ppm including CF₄ as the processing target gas 201 and H₂ as the auxiliary gas 203 may be supplied through the gas inlet 50 of the plasma reactor 100 at a flow rate of 10 Lpm under the N₂ balance condition. N₂ is the plasma driving gas 202, and H₂ is the auxiliary gas 203. Decomposition performance evaluation may be performed by changing the content of H₂ with respect to CF₄ to 0, 0.5, 1, 2, and 5, and results thereof are shown in Table 1 below.

TABLE 1

| | | | Consumed | CF₄ | Energy |
|---|---|---|---|---|---|
| [H₂]/ | | | power | removal | efficiency |
| [CF₄] | CF₄(ppm) | H₂(ppm) | (W) | rate | (gCF₄/kWh) |
| 0 | 3000 | 0 | 613 | 12.56 | 1.33 |
| 0.5 | 3000 | 1500 | 771 | 79.16 | 7.98 |
| 1 | 3000 | 3000 | 891 | 84.63 | 8.57 |
| 2 | 3000 | 5000 | 932 | 84.08 | 7.92 |
| 5 | 3000 | 15000 | 993 | 81.53 | 8.24 |

Referring to FIGS. 10 and 11 and Table 1, H₂ promotes ionization of CF₄ due to lower binding energy compared to N₂, and accordingly, a current and output of the plasma reactor 100 may be increased. Also, a reverse reaction may be prevented during a decomposition process of CF₄. Therefore, H₂ may cause a significant change in a removal rate of CF₄ and energy efficiency. In order to completely prevent a reverse reaction of one molecule of CF₄, two molecules of H₂ may be required, and referring to FIGS. 10 and 11 and Table 1, high energy efficiency and removal rate of CF₄ are observed starting from a ratio of 0.5 of [H₂]/[CF₄]. This effect may occur due to a change in plasma characteristics by H₂, and is hardly found in a conventional plasma reactor of a transfer type or non-transfer type.

According to the embodiments of a plasma reactor for gas reforming described above and a gas reforming apparatus and method using the plasma reactor, processing target gas, plasma driving gas, and auxiliary gas may be supplied to a gas supply region of a reaction space of the plasma reactor, and mixed gas thereof may be supplied to a discharging region through a boundary region to convert the mixed gas into plasma, and thus, energy efficiency may be improved. Also, by reforming gas by using plasma, the startup time may be reduced.

Although embodiments are described in detail with reference to the attached drawings, the present inventive concept is not limited to the embodiments. It is obvious that a person having ordinary knowledge in the technical field to which the present inventive concept belongs may derive various embodiments of changes or modifications within the scope of the technical idea described in the patent claims, and the various embodiments also naturally fall within the technical scope of the present inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A gas reforming apparatus for converting processing target gas into reformed gas, the gas reforming apparatus comprising:
a gas supply unit, which supplies the processing target gas, plasma driving gas, and auxiliary gas for preventing a reverse reaction of the reformed gas;
a plasma reactor, which receives the processing target gas, the plasma driving gas, and the auxiliary gas and converts the processing target gas into the reformed gas by using plasma generated by arc discharging; and
a gas storage, which receives the reformed gas discharged from the plasma reactor,
wherein the plasma reactor comprises:
a housing having a reaction space therein, at least one gas inlet connected to the gas supply unit, and a gas outlet through which the reformed gas is discharged,
a ground electrode arranged in the reaction space and forming an inner wall of the reaction space, and
a high-voltage electrode arranged inside the reaction space to face the ground electrode and which generates the arc discharging,
the high-voltage electrode has a cone shape including an enlargement portion, a reduction portion, and a boundary portion between the enlargement portion and the reduction portion,
the reaction space includes a gas supply region between the enlargement portion and the inner wall, a discharging region which is a region between the reduction portion and the inner wall and in which the arc discharging occurs, and a connection region which is a region between the boundary portion and the inner wall and connects the gas supply region to the discharging region, and
the at least one gas inlet is connected to the gas supply region.

2. The gas reforming apparatus of claim 1, wherein the connection region forms a bottleneck portion between the gas supply region and the discharging region.

3. The gas reforming apparatus of claim 1, wherein an angle of the enlargement portion with respect to a reference line orthogonal to a gas flow direction is greater than an angle of the reduction portion with respect to the reference line.

4. The gas reforming apparatus of claim 1, further comprising a mixer, which form mixed gas by mixing the processing target gas, the plasma driving gas, and the auxiliary gas,
wherein the at least one gas inlet is connected to the mixer such that the mixed gas is supplied to the gas supply region of the reaction space.

5. The gas reforming apparatus of claim 1, wherein the processing target gas, the plasma driving gas, and the auxiliary gas are individually supplied to the at least one gas inlet and mixed with each other in the gas supply region of the reaction space.

6. The gas reforming apparatus of claim 1, wherein the processing target gas includes at least one of nitrogen oxide and fluorocarbon.

7. The gas reforming apparatus of claim 1, wherein the auxiliary gas includes at least one of hydrogen, oxygen, water vapor, argon, and helium.

8. A plasma reactor for converting processing target gas into reformed gas, comprising:
a housing having a reaction space therein, at least one gas inlet through which the processing target gas, plasma driving gas, and auxiliary gas for preventing a reverse reaction of the reformed gas are injected into the reaction space, and a gas outlet through which the reformed gas is discharged;
a ground electrode arranged in the reaction space and which forms an inner wall of the reaction space; and
a high-voltage electrode arranged in the reaction space to face the ground electrode and which generates arc discharging,
wherein the high-voltage electrode has a cone shape including an enlargement portion, a reduction portion, and a boundary portion between the enlargement portion and the reduction portion,
the reaction space includes a gas supply region between the enlargement portion and the inner wall, a discharging region which is a region between the reduction portion and the inner wall and in which the arc discharging occurs, and a connection region which is a region between the boundary portion and the inner wall and connects the gas supply region to the discharging region, and
the at least one gas inlet is connected to the gas supply region.

9. The plasma reactor of claim 8, wherein the connection region forms a bottleneck portion between the gas supply region and the discharging region.

10. The plasma reactor of claim 8, wherein an angle of the enlargement portion with respect to a reference line orthogonal to a gas flow direction is greater than an angle of the reduction portion with respect to the reference line.

11. The plasma reactor of claim 8, wherein the at least one gas inlet is formed in a tangential direction with respect to the inner wall of the gas supply region.

12. The plasma reactor of claim 8, wherein the at least one gas inlet is formed in a direction orthogonal to the inner wall of the gas supply region.

13. The plasma reactor of claim 8, wherein the processing target gas includes at least one of nitrogen oxide and fluorocarbon.

14. The plasma reactor of claim 8, wherein the auxiliary gas includes at least one of hydrogen, oxygen, water vapor, argon, and helium.

15. A gas reforming method comprising:
supplying the processing target gas, the plasma driving gas, and the auxiliary gas to the gas supply region of the reaction space through the at least one gas inlet of the plasma reactor according to claim 8;
supplying mixed gas of the processing target gas, the plasma driving gas, and the auxiliary gas to the discharging region through the connection region to form a turbulence of the mixed gas in the discharging region;
applying a pulse voltage to the high-voltage electrode of the plasma reactor to form plasma in the discharging region;
converting the processing target gas into the reformed gas by energy exchange with the plasma; and
discharging the reformed gas from the plasma reactor.

16. The gas reforming method of claim 15, wherein the supplying of the processing target gas, the plasma driving gas, and the auxiliary gas to the gas supply region comprises:
supplying the processing target gas, the plasma driving gas, and the auxiliary gas to a mixer to form the mixed gas; and
supplying the mixed gas to the gas supply region through the at least one gas inlet.

17. The gas reforming method of claim 15, wherein the supplying of the processing target gas, the plasma driving gas, and the auxiliary gas to the gas supply region comprises:
individually supplying the processing target gas, the plasma driving gas, and the auxiliary gas to the at least one gas inlet; and
mixing the processing target gas, the plasma driving gas, and the auxiliary gas in the gas supply region to form the mixed gas.

18. The gas reforming method of claim 15, wherein the processing target gas includes at least one of nitrogen oxide and fluorocarbon.

19. The gas reforming method of claim 15, wherein the auxiliary gas includes at least one of hydrogen, oxygen, water vapor, argon, and helium.

20. The gas reforming method of claim 15, wherein the pulse voltage has a pulse width of about 1 microsecond (μs) to about 100 μs and a pulse period of about 1 KHz to about 100 kHz.
